(19) United States
(12) Patent Application Publication
(10) Pub. No.: US 2003/0149566 A1
(43) Pub. Date: Aug. 7, 2003

(54) System and method for a spoken language interface to a large database of changing records

(76) Inventors: Esther Levin, Livingston, NJ (US); Susan Boyce, Rumson, NJ (US); Brian Helfrich, New York, NY (US); Yevgeniy Lyudovyk, Woodbridge, NJ (US); Robert Burke, Morristown, NJ (US); Ilija Zeljkovic, Scotch Plains, NJ (US)

Correspondence Address: KENYON & KENYON, 1500 K STREET, N.W., SUITE 700, WASHINGTON, DC, 20005, US

(21) Appl. No.: 10/331,343

(22) Filed: Dec. 31, 2002

Related U.S. Application Data
(60) Provisional application No. 60/343,597, filed on Jan. 2, 2002.
(60) Provisional application No. 60/343,588, filed on Jan. 2, 2002.
(60) Provisional application No. 60/343,590, filed on Jan. 2, 2002.
(60) Provisional application No. 60/343,595, filed on Jan. 2, 2002.
(60) Provisional application No. 60/343,596, filed on Jan. 2, 2002.
(60) Provisional application No. 60/343,593, filed on Jan. 2, 2002.
(60) Provisional application No. 60/343,592, filed on Jan. 2, 2002.
(60) Provisional application No. 60/343,589, filed on Jan. 2, 2002.
(60) Provisional application No. 60/343,591, filed on Jan. 2, 2002.

(51) Int. Cl. G10L 15/14

(52) U.S. Cl. 704/256

(57) ABSTRACT

Embodiments of the present invention provide a spoken language interface to an information database. A grammars database based on the entries contained in the information database may be generated. The entries in the grammars database may be a compact representation of the entries in the information database. An index database based on the entries contained in the information database may be generated. The grammars database and the index database may be updated periodically based on updated entries contained in the information database. A recognized result of a user's communication based on the updated grammars database may be generated. The updated index database may be searched for a list of matching entries that match the recognized result. The list of matching entries may be output.

### CROSS-REFERENCE TO RELATED PATENT APPLICATIONS

This patent application claims the benefit of, and incorporates by reference, each of: U.S. Provisional Patent Application Serial No. 60/343,597, U.S. Provisional Patent Application Serial No. 60/343,588, U.S. Provisional Patent Application Serial No. 60/343,590, U.S. Provisional Patent Application Serial No. 60/343,595, U.S. Provisional Patent Application Serial No. 60/343,596; U.S. Provisional Patent Application Serial No. 60/343,593, U.S. Provisional Patent Application Serial No. 60/343,592, U.S. Provisional Patent Application Serial No. 60/343,589, and U.S. Provisional Patent Application Serial No. 60/343,591, all filed Jan. 2, 2002.

### TECHNICAL FIELD

The present invention relates to automatic directory assistance. In particular, the present invention relates to systems and methods for providing a spoken language interface to a dynamic database.

### BACKGROUND OF THE INVENTION

In recent years, automated attendants have become very popular. Many individuals or organizations use automated attendants to automatically provide information to callers and/or to route incoming calls. An example of an automated attendant is an automated directory assistant that automatically provides a telephone number, address, etc. for a business or an individual in response to a user's request.

Typically, a user places a call and reaches an automated directory assistant (e.g. an Interactive Voice Recognition (IVR) system) that prompts the user for desired information and searches an informational database (e.g., a white pages listings database) for the requested information. The user enters the request, for example, a name of a business or individual via a keyboard, keypad or spoken inputs. The automated attendant searches for a match in the informational database based on the user's input and may output a voice synthesized result if a match can be found.

In cases where a very large information database such as the white pages listings database needs to be searched, developers may use statistical grammars such as stochastic language models to efficiently recognize a user's communication and find an accurate result for a request by the user. Using conventional techniques, a large corpus of user utterances, for example, in the context of the underlying application, is collected and transcribed. This corpus is used to estimate parameters for the stochastic language models.

The corpus has to be large enough to sufficiently represent all possible word sequences that a user might utter or input in the context of the application. For an application such as directory assistance, where the users may choose from millions of listing names, and where new listings are being added every day, collection of such corpus can be very difficult.

### SUMMARY OF THE INVENTION

Embodiments of the present invention provide a spoken language interface to an information database. A grammars database based on the entries contained in the information database may be generated. The entries in the grammars database may be a compact representation of the entries in the information database. An index database based on the entries contained in the information database may be generated. The grammars database and the index database may be updated periodically based on updated entries contained in the information database. A recognized result of a user's communication based on the updated grammars database may be generated. The updated index database may be searched for a list of matching entries that match the recognized result. The list of matching entries may be output.

### BRIEF DESCRIPTION OF THE DRAWINGS

Embodiments of the present invention are illustrated by way of example, and not limitation, in the accompanying figures in which like references denote similar elements, and in which:

FIG. 1 is a block diagram of an automated communication processing system in accordance with an embodiment of the present invention;

FIG. 2 illustrates a block diagram in accordance with an embodiment of the present invention;

FIG. 3 illustrates a block diagram in accordance with an embodiment of the present invention; and

FIG. 4 is flowchart showing an automated communication processing system in accordance with an exemplary embodiment of the present invention.

### DETAILED DESCRIPTION

Embodiments of the present invention relate to a method and apparatus for automatically recognizing and/or processing a user's communication. The invention relates to a method and apparatus for building a system that provides an automatic interface such as an automatic spoken language interface to an information database. This information database may include entries or records that may be changing. Some records may be added while others are deleted, still other records may need updating because the information included in the records has changed.

In embodiments of the present invention, the system may separate the task of speech recognition from an index search task. These tasks may be performed to automatically recognize and/or process the user's communication such as a request for information from the information database. An automated recognition process such as a speech recognition process to recognize the user's communication may use a grammars database. The grammars database may be based on compact representation of entries or records in the index database and/or the information database.

The results of the speech recognition process may be independent from a record or a set of records included in the index database. A separate index search process to search the index database may use the results of the speech recognition process. This technique may be used by the system to process the user's communications such as a request for information. If a match is found, the information may be automatically presented to the user.

In embodiments of the present invention, the grammar database used by the speech recognition process, and/or the index database used by the index search process, may be updated periodically. These databases may be updated based on a dynamic information database such as a listings database. As indicated above, the information database may be in a state of constant flux due to entries that are being constantly added, deleted, updated, etc. Accordingly, the grammar database and/or the index database may be updated periodically to reflect the changes in the information database. Advantageously, an updated grammars database and/or an updated index database may improve the efficiency and/or accuracy of the system.

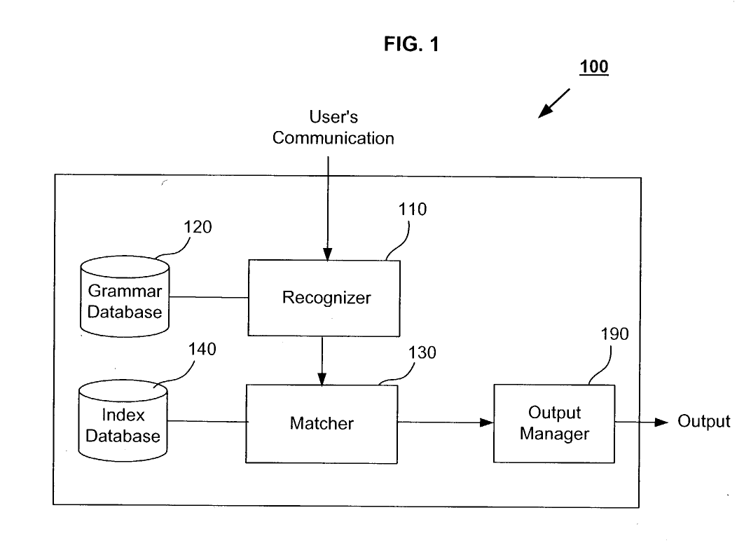

FIG. 1 is an exemplary block diagram of an automated communication processing system 100 for processing a user's communication in accordance with an embodiment of the present invention. A recognizer 110 is coupled to a grammar database 120 and a matcher 130 that is coupled to an index database 140. The matcher may be coupled to an output manager 190 that provides an output from the automated processing system 100.

In embodiments of the present invention, the user's input may be speech input that may be input from a microphone, a wired or wireless telephone, other wireless device, a speech wave file or other speech input device.

While the examples discussed in the embodiments of the patent concern recognition of speech, the recognizer 110 may also receive a user's communication or inputs in the form of speech, text, digital signals, analog signals and/or any other forms of communications or communications signals.

As used herein, user's communication can be a user's input in any form that represents, for example, a single word, multiple words, a single syllable, multiple syllables, a single phoneme and/or multiple phonemes. The user's communication may include a request for information, products, services and/or any other suitable requests.

A user's communication may be input via a communication device such as a wired or wireless phone, a pager, a personal digital assistant, a personal computer, and/or any other device capable of sending and/or receiving communications. In embodiments of the present invention, the user's communication could be a search request to search the World Wide Web (WWW), a Local Area Network (LAN), and/or any other private or public network for the desired information.

In embodiments of the present invention, the recognizer 110 may be any type of recognizer known to those skilled in the art. In one embodiment, the recognizer may be an automated speech recognizer (ASR) such as the type developed by Nuance Communications. The communication processing system 100, where the recognizer 110 is an ASR, may operate similar to an IVR but includes the advantages of an grammars database 120 and/or index database 140 that may be periodically updated in accordance with embodiments of the present invention.

In alternative embodiments of the present invention, the recognizer 110 can be a text recognizer, optical character recognizer and/or another type of recognizer or device that recognizes and/or processes a user's inputs, and/or a device that receives a user's input, for example, a keyboard or a keypad. In embodiments of the present invention, the recognizer 110 may be incorporated within a personal computer, a telephone switch or telephone interface, and/or an Internet, Intranet and/or other type of server.

In an alternative embodiment of the present invention, the recognizer 110 may include and/or may operate in conjunction with, for example, an Internet search engine that receives text, speech, etc. from an Internet user. In this case, the recognizer 110 may receive user's communication via an Internet connection and operate in accordance with embodiments of the invention as described herein.

In one embodiment of the present invention, the recognizer 110 receives the user's communication and generates a recognized result that may include a list of recognized entries, using known methods. The recognition of the user's input may be carried out using a grammar database 120.

As an example, the grammar database 120 may be a statistical N-gram grammar such as a uni-gram grammar, bi-gram grammar, tri-gram grammar, etc. The initial grammar 120 may be word-based grammar, subword-based grammar, phoneme-based grammar, or grammar based on other types of symbol strings and/or any combination thereof.

In embodiments of the present invention, the grammar database 120 may be extracted from and/or created based on an information database such as a listings database that may include residential, governmental, and/or business listings for a particular town, city, state, and/or country. In accordance with embodiments of the present invention the grammar database 120 may be created and/or periodically updated using a distortion model (to be discussed below in more detail).

In embodiments of the present invention, the index database 140 may include a database look-up table for a larger informational database such as a listings database. The index database 140 may include, for example, listing entries such as a name of a business or individual. Each entry may include a record identifier (record ID) that indicates the location of additional information, in an underlying listings database, associated with the listing entry. Thus, the index database 140 may include an index for the larger listings or information database.

In embodiments of the present invention, a user's communication may be received by recognizer 110. The recognizer may generate a recognition result using the grammar database 120. The recognition result may include a list of N-best recognized entries where, where N may be may be a pre-defined integer such as 1, 2, 3 . . . 100, etc. The recognition result may be a hypothesis of the user's input as recognized by the recognizer 110.

In embodiments of the present invention, each entry in the list of recognized entries generated by the recognizer 110 may be ranked with an associated first confidence score. The confidence score may indicate the level of confidence or likelihood of the hypothesis that this recognized entry is what was uttered (input) by the user. A higher first confidence score associated with a recognized entry may indicate a higher likelihood of the hypothesis that this recognized entry is what was uttered (input) by the user.

In embodiments of the preset invention, the list of recognized entries may be input to a matcher 130. The matcher 130 may search index database 140 for a list of matching listing entries. The list of matching entries along with record IDs associated with each entry may be output by the matcher 130. The record ID may be used to access the additional information from the listings database. The system 100 may access such additional information for each entry in the list of matching entry, or alternatively, the system may use a dialog with a user to confirm the listing, from the list, for which the user desires additional information before accessing the additional information. Such dialog and/or further processing may be conducted using output manager 190.

In embodiments of the invention, the dialog manager 190 may request the user to specify which information is requested for the listing. For example, once the user confirms the listing from the list of matched entries, the output manager 190, may request the user to indicate whether, for example, an address and or a phone number for the confirmed listing is requested. The requested information may be retrieved from the listings database and efficiently provided to the user. It is recognized that the index database 140 may include the additional information so that there may be no need to access the listings database for such information such as an address, phone number, e-mail address, etc. for each listing or entry.

It is recognized that the stored entries in the index database 140 or other informational database could represent or include a myriad of other types of information such as individual directory information, specific business or vendor information, postal addresses, e-mail addresses, etc. Such databases may include residential, governmental, and/or business listings for a particular town, city, state, and/or country.

In embodiments of the present invention, the database 140 can be part of larger database of listings information such as a database or other information resource that may be searched by, for example, any Internet search engine when performing a user's search request.

In embodiments of the present invention, a first confidence score may be generated for each entry in the recognition results by the speech recognizer. This technique may be used to limit the number of entries in the list of recognized entries to N-best entries based on a recognition confidence threshold (e.g., THR1). For example, the recognizer 110 may be set with a minimum recognition threshold. Entries having a corresponding first confidence score equal to and/or above the minimum recognition threshold may be included in the list of recognized N-best entries.

In embodiments of the present invention, entries having a corresponding first confidence score less than the minimum recognition threshold may be omitted from the list. The recognizer 110 may generate the first confidence score, represented by any appropriate number, as the user's communication is being recognized. The recognition threshold may be any appropriate number that is set automatically or manually, and may be adjustable, based on, for example, on the top-best confidence scores. It is recognized that other techniques may be used to select the N-best results or entries.

In embodiments of the present invention, the entries in the recognized list of entries may be a sequence of words, sub-words, phonemes, or other types of symbol strings and/or combination thereof.

Each entry in the recognized list of entries may be text or character strings that represent a hypothesis of what the user said in response to a question like “What listing please?” In one example, a recognized entry may be the name of a business for which the user desires a telephone number. Each entry included in the list of entries generated by the recognizer 110 may be a hypothesis of what was originally input by the user.

In embodiments of the present invention, as indicated above, the recognized list of entries generated by the recognizer by the recognizer 110 may be input to matcher 130. The matcher 130 may receive the N-best recognition results with corresponding first confidence scores and may search database 140. The matcher 130 may generate a list of one or more matching entries. The list of matching entries may represent, for example, what the caller had in mind when the caller inputs the communication into recognizer 110.

The matching algorithm employed by matcher 130 may be based on words, sub-word, phonemes, characters or other types of symbol strings and/or any combination thereof. For example, matcher 130 can be based on N-grams of words, characters or phonemes.

In embodiments of the present invention, the list of matching entries generated by the matcher 130 may be a list of M-best matching entries, where M may be may be a pre-defined integer such as 1, 2, 3 . . . 100, etc. Alternatively, each entry in the list of matching entries generated by the matcher 130 may be ranked with an associated second confidence score. The second confidence score may indicate the level of confidence (or likelihood) that a particular matching entry is the entry in database 140 that the user had in mind when she uttered the utterance. A higher second confidence score associated with a matching entry may indicate a higher level of likelihood that this particular matching entry is the entry that the user had in mind when she uttered the utterance.

In embodiments of the present invention, the second confidence score may be used to limit the entries in the list of matching entries to M-best entries based on a matching threshold (e.g., THR2). For example, the matcher 130 may be set with a minimum matching threshold. Entries having a corresponding second confidence score equal to and/or above the minimum matching threshold may be included in the list of matching M-best entries.

In embodiments of the present invention, entries having a corresponding second confidence score less than the minimum matching threshold may be omitted from the list. The matcher 130 may generate the confidence score, represented by any appropriate number, as the database 140 is being searched for a match. The matching threshold may be any appropriate number that is set automatically or manually, and may be adjustable based on, for example, on the top-best confidence scores. It is recognized that other techniques may be used to select the M-best entries.

In an exemplary embodiment of the present invention, the matcher 130 may, for example, extract one or more recognized N-grams from each entry in list of recognized entry generated by the recognizer 110. The matcher 130 may search all of the entries in the database 140 to find a match for each of the recognized N-grams. Based on the matched entries, the matcher 130 may generate a list of M-best matching entries including a corresponding second confidence score for each matched entry in the list.

In an embodiment of the present invention, the list of M-best matching entries may be output to a user for presentation and/or confirmation via output manager 190.

In embodiments of the present invention, the matcher 130 may output to the output manager 190 for further processing. For example, depending on the distribution of the various confidence scores associated with each entry in the list of N-best and/or M-best entries, and/or some other parameter, the output manager 190 may automatically route a call and/or present requested information to the user without user intervention.

Depending on the distributions and/or parameters, the output manager 190 may forward the list of N-best and/or M-best matching entries to the user for selection of the desired entry. Based on the user's selection, the output manager 190 may route a call for the user, retrieve and present the requested information, or perform any other function.

In embodiments of the present invention, depending on the same distributions, the output manager 190 may present another prompt to the user, terminate the session if the desired results have been achieved, or perform other steps to output a desired result for the user. If the output manager 190 presents another prompt to the user, for example, asks the user to input the desired listings name once more, another list of M-best matching entries may be generated and may be used to help the output manager 190 to make the final decision about the user's goal.

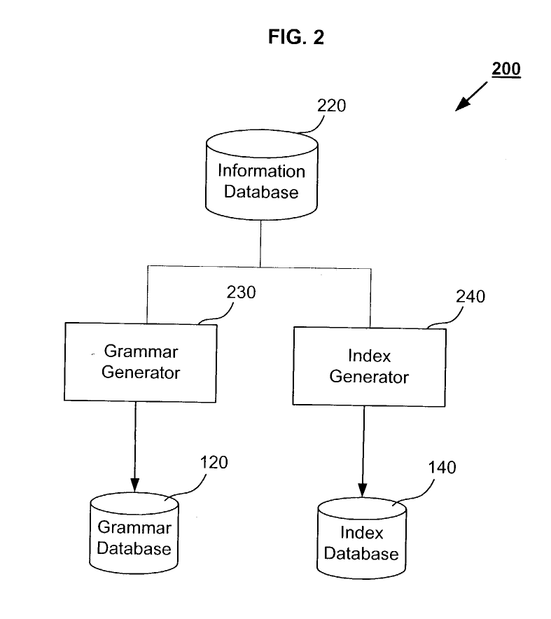

FIG. 2 illustrates a diagram of an off-line processing system 200 in accordance with an embodiment of the present invention. As shown, an information database 220 may be periodically extracted by a grammar generator 230 to generate grammars 120. The information database 220 may also be periodically extracted by index generator 240 to generate index database 140. These databases such as grammar database 120 and/or index database may be employed by the automated communications system 100, in accordance with embodiments of the present invention.

These information database 220 may be extracted periodically based on a predetermined schedule such as once a day, week, etc. Optionally and/or additionally, the database 220 may be extracted based on dynamic criteria such as threshold number of changes made to the database 220. For example, if a threshold number of entries (e.g., 5, 6, 19, 15, etc.) are updated, edited, added, and/or deleted, then such an event may trigger the extraction of database 220 to update grammar data base 120 and/or index database 140.

In embodiments of the present invention, the index generator 240 may update, add, delete, etc. the entry name and/or a corresponding record identifier (record ID) as the information database 220 changes. For example, if a new record is added, then that entry along with the location of the entry (e.g., the record ID) in database 220 may be added to the index database 140 by generator 240. If an entry is deleted in the database 220 and/or the record ID is changed, then the index generator 240 may update the index database 140 to reflect the change.

In embodiments of the present invention, the grammars in database 120 may be computed by estimated N-gram statistics such as bi-gram statistics. It is recognized that other N-gram statistics such as unigram, tri-gram, etc. may be used.

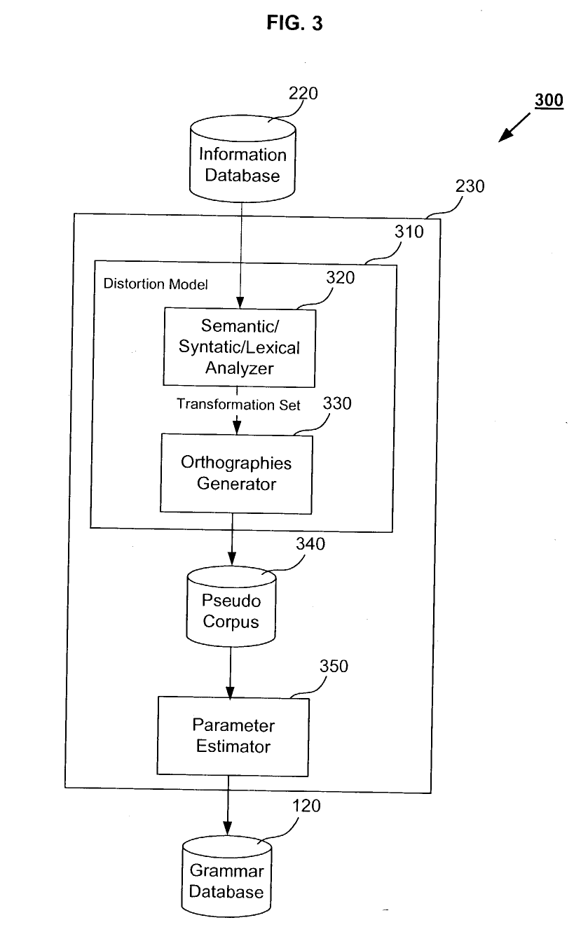

In embodiments of the present invention, the listings database 220 may be extracted by grammar generator 230 to generate grammar database 120, as shown in FIG. 3. FIG. 3 is a detailed block diagram of grammar generator 230 in accordance with embodiments of the present invention.

In accordance with embodiments of the present invention, the entries in listings database 220 may be processed by a distortion model 310. The distortion model 310 may dynamically generate the different ways an entry in the listings database 220 may be input or pronounced by a user. The output of the distortion model 310 may be used to create a pseudo-corpus 340 from which the probabilities needed for stochastic language model may be estimated by the parameter estimator 350. Accordingly, the grammars of database 120 may be dynamically generated and/or updated in accordance with embodiments of the present invention.

In embodiments of the present invention, the distortion model 310 may process each listing of database 220 through a semantic/syntactic/lexical analyzer 320. The analyzer 320 may generate a transformation set that specifies the possible transformation rules to apply to the listing name. For example, the analyzer 320 may generate transformation rules that specify how a user may alter and/or distort a requested listing. For example, these transformation rules may state that any word omission is always possible, but words can change their order only if the listing name contains words like “and”, “or”, “by”, etc. The rules may also specify appropriate word and/or phrase substitutions. For example, a rule may state that the word ‘pizzeria’ may be substituted with a word ‘pizza’. The rules contained in the analyzer 320 may also determine the probability for each type of distortion.

It is recognized that the transformation rules described above are given by way of example only, and any number of different types of transformation rules may be used by analyzer 320. In accordance, with embodiments of the present invention, these transformation rules may indicate how a listing may be altered and/or distorted. As indicated above, this altered or distorted listing may indicate how users may alter the listing when requesting information such as directory assistance.

In embodiments of the present invention, the orthographies generator 330 may apply the transformation rules (e.g., included in the transformation set) generated by the analyzer 320 to each listing to generate the listing's orthographies. In embodiments of the present invention, these orthographies may be one or more variation of the listing that may be generated based on the applied rules. These variations may reflect how a user may input the listing.

In embodiments of the present invention, the orthographies generator 330 may output the orthographies and the associated probability for each orthography to the pseudo corpus 340. The probability may indicate the possibility or likelihood that the variation or orthography of the listing would be input by a user.

In embodiments of the present invention, instead of explicitly creating a pseudo-corpus 340, the distortion model 310 may output the orthographies and/or associated probabilities directly to the parameter estimator 350 for processing.

In embodiments of the present invention, the parameter estimator 350 may employ conventional parameter estimation techniques such as counting word or N-Gram frequencies to generate a stochastic language model for the application that covers all the listings in the database 220. It is recognized that parameter estimator 350 may apply any conventional technique to generate the stochastic language model for the application that covers all the listings in the database 220.

In embodiment of the present invention, the distortion model 310 may process each listing in the database 220 to create orthographies or a set of possible word sequences (e.g., variations of word sequences) that may be uttered or input by the user. Each word sequence variation may include an associated probability indicator (prob.) that may specify the probability that this word sequence is to be input or uttered by the user who desires, for example, directory assistance for the listing.

In embodiments of the present invention, for example, the database 220 may include the listing “Creative Nails by Danny.” The distortion model 310 may produce the following orthographies with the associated probabilities:

Creative Nails by Danny; prob.=0.5

Danny Nails; prob.=0.2

Nails by Danny; prob.=0.2

Creative Nails; prob.=0.1

The probability (prob.) the distortion model 310 may assigns to each orthography may be a conditional probability of an orthography produced by the user given that a specific listing is the one that the user seeks. Thus, for example, the probability that the user will say “Danny nails” when requesting for the listing “Creative Nails by Danny” may be determined to be 0.2 or 20%. As indicated above, the orthographies and associated probabilities may be sent to a pseudo corpus 340 and/or may be sent directly to the parameter estimator 350 for processing.

In embodiments of the present invention, prior or historical probabilities may be applied to generate the probability (e.g., prob.) associated with each orthography. This can be done either within the distortion model, or later at the parameter estimation step. In the example above, the probabilities for all orthographies for “Creative Nails by Danny” sum up to 100%. The prior probability may be based on, for example, exiting prior knowledge that this listing is requested only 0.01% of all listing requests. Accordingly, using this prior probability, for example, the probabilities above should be multiplied by 0.0001 to reflect this prior knowledge.

In another example, the prior probability may be generated based on the manner the listing may have been referred to and/or been input in the past by users. When prior knowledge is taken into account, the sum of all probabilities for all orthographies for all listings should be 100%. It is understood the above described ways of generating probabilities are given by way of example only and that other techniques may be used to generate the probability associated with each listing orthography.

In accordance with embodiments of the present invention, the grammar generator 230 can periodically update the underlying grammar database 120 so that accurate results can be obtained from the automated information communication system 100.

Although the above description with reference to FIG. 3 is described with specific reference to the grammar generator 230 and grammar 120, it is recognized that the index generator 240 may operate similarly to update the index database, in accordance with embodiments of the present invention. For example, the index generator 240 may include distortion model 310, pseudo corpus 340 and/or parameter estimator 350, in accordance with embodiments of the present invention.

Embodiments of the present invention provide an automated communication information system where the grammar and/or index databases may be dependent on the underlying database. For example, in a residential listing case, the most frequent 100,000 names can be recomputed when the listing database is updated. Advantageously, this can result in better information coverage and more accurate results by the automated system.

Embodiments of the present invention may find application in a variety of different recognizers such as speech recognizers that use phonetics and/or stochastic language models. In case of a phonetic recognizer, the statistics used in the phonetic grammar may not represent general English language, but rather only the relevant utterances dependent on the current content of the database. Another, very important example is using stochastic grammars (like n-grams) that are based on the statistics of words, sub-words and sequences of words extracted from the current database content.

In embodiments of the present invention, the grammars and the index database 140 associated with the database search engine may be updated when the content of the database changes.

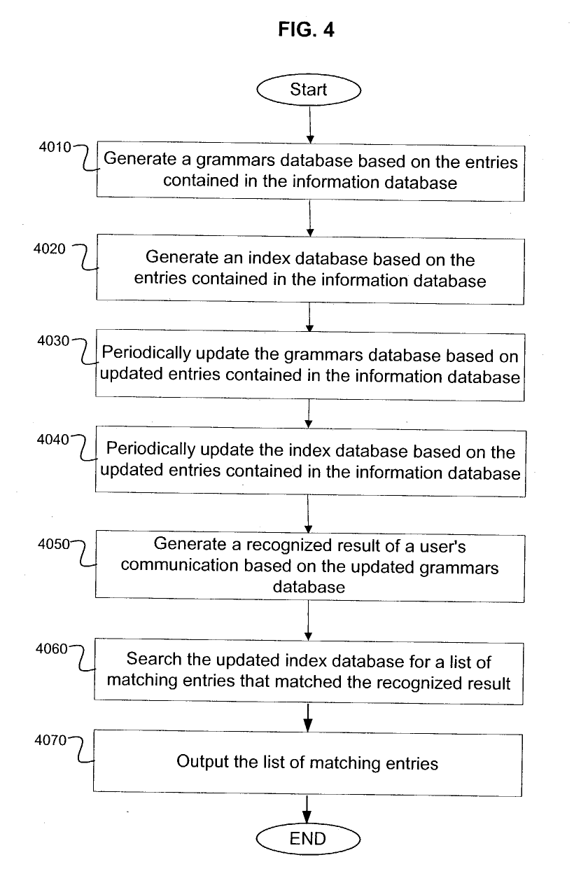

FIG. 4 is a flow chart in accordance with an embodiment of the present invention. As shown in 4010, a grammars database may be generated based on entries contained in an information database. In embodiments of the present invention, the entries in the grammars database may be a compact representation of the entries in the information database. For example, the entries in the grammars database may not directly correspond to entries in the listings database. An index database may be generated based on the entries contained in the information database, as shown in 4020.

In embodiments of the present invention, the grammars database may be periodically updated based on updated entries contained in the information database, as shown in 4030. As shown in 4040, the index database may be periodically updated based on the updated entries contained in the information database. A recognized result of a user's communication may be generated based on the updated grammars database, as shown in 4050.

In embodiments of the present invention, the updated index database may be searched for a list of matching entries that matched the recognized result, as shown in 4060. Additionally or optionally, the listings database may be searched for a list of matching entries that matched the recognized result using the updated index database.

As shown in 4070, the list of matching entries may be output. In one example, the list of matching entries may be output to a user for confirmation via an output manager. Alternatively, the list of matching entries may be used to retrieve a record ID or the like. The record ID, for example, may be used to look up information or entry in an information or listings database. That information may be presented to a user.

It is recognized that the device and/or systems incorporating embodiments of the invention may include one or more processors, one or more memories, one or more ASICs, one or more displays, communication interfaces, and/or any other components as desired and/or needed to achieve embodiments of the invention described herein and/or the modifications that may be made by one skilled in the art. It is recognized that a programmer and/or engineer skilled in the art to obtain the advantages and/or functionality of the present invention may develop suitable software programs and/or hardware components/devices. Embodiments of the present invention can be employed in known and/or new Internet search engines, for example, to search the World Wide Web.

Several embodiments of the present invention are specifically illustrated and/or described herein. However, it will be appreciated that modifications and variations of the present invention are covered by the above teachings and within the purview of the appended claims without departing from the spirit and intended scope of the invention.

What is claimed is:

1. A method for providing a spoken language interface to an information database, comprising:
generating a grammars database based on the entries contained in the information database, wherein entries in the grammars database are a compact representation of the entries in the information database;
generating an index database based on the entries contained in the information database;
periodically updating the grammars database based on updated entries contained in the information database;
periodically updating the index database based on the updated entries contained in the information database;
generating a recognized result of a user's communication based on the updated grammars database;
searching the updated index database for a list of matching entries that match the recognized result; and
outputting the list of matching entries.

2. The method of claim 1, wherein generating the grammars database comprises:
generating entries in the grammars database based on the entries in the information database using estimated N-gram statistics.

3. The method of claim 2, wherein entries in the grammars database include bi-gram grammars.

4. The method of claim 1, wherein periodically updating the grammars database comprises:
generating entries in the grammars database based on the entries in the information database using estimated N-gram statistics.

5. The method of claim 1, wherein the entries in the grammars database do not directly correspond to entries in the listings database.

6. The method of claim 1, wherein the information database is a listings database.

7. The method of claim 1, wherein the grammars database is updated daily, weekly or monthly.

8. The method of claim 1, wherein the index database is updated daily, weekly or monthly.

9. The method of claim 1, wherein periodically updating the grammars database comprises:
processing a plurality of entries of the information database through a distortion model.

10. The method of claim 9, further comprising:
generating a transformation rule set for each entry from the plurality of entries; and
transforming each entry into a variation of the entry based on the rule set.

11. The method of claim 10, furthering comprising:
generating a probability associated with the variation of the entry.

12. The method of claim 11, further comprising:
creating a pseudo corpus including the variation and the associated probability.

13. The method of claim 11, further comprising:
generating a language model based on the variation and the associated probability using parameter estimation.

14. The method of claim 1, further comprising:
searching the listing database for the list of matching entries that matched the recognized result based on the updated index database.

15. The method of claim 1, wherein periodically updating the index database comprises:
processing a plurality of entries of the information database through a distortion model.

16. The method of claim 15, further comprising:
generating a transformation rule set for each entry from the plurality of entries; and
transforming each entry into a variation of the entry based on the rule set.

17. The method of claim 16, furthering comprising:
generating a probability associated with the variation of the entry.

18. A method comprising:
retrieving each entry of a plurality of entries contained in an informational database;
applying a transformation rule to each entry of the plurality of entries in the informational database;
generating a variation of each entry based on the applied transformation rule;
generating an associated probability for each variation; and
generating a stochastic language model for each variation and the associated probability based a parameter estimation technique.

19. The method of claim 18, wherein the informational database is a listings database.

20. The method of claim 18, wherein the variation of an entry is a distortion of the entry in the informational database.

21. The method of claim 18, further comprising:
outputting the generated stochastic language model into a grammar database.

22. The method of claim 18, further comprising:
outputting the generated stochastic language model into an index database.

23. The method of claim 18, wherein the transformation rule specify an alternate way of uttering an entry.

24. The method of claim 23, further comprising:
generating a pseudo corpus based on each variation and the associated probability.

25. The method of claim 18, wherein the variation includes an alternate word sequence representing an entry in the informational database.

26. An apparatus for providing a spoken language interface to an information database, comprising:
a grammar generator that is to periodically update a grammars database based on updated entries contained in an information database, wherein entries in the grammars database are a compact representation of the entries in the information database;
a index generator that is to periodically update an index database based on the updated entries contained in the information database;
a recognizer that is to generating a recognized result of a user's communication based on the updated grammars database;
a matcher that is to search the updated index database for a list of matching entries that match the recognized result; and
an output manager to output the list of matching entries.

27. The apparatus of claim 26, wherein the grammar database is to periodically update entries in the grammars database based on the entries in the information database based on estimated N-gram statistics.

28. The apparatus of claim 26, wherein the entries in the grammars database do not directly correspond to entries in the listings database.

29. The apparatus of claim 26, wherein the grammar generator comprises:
a distortion model that is to generate a variation of an entry in the information database.

30. The apparatus of claim 29, wherein the distortion model comprises:
an analyzer that is to generate a transformation rule; and
an orthographies generator that is to generate the variation of the entry in the information database based on the generated transformation rule.

31. The apparatus of claim 30, wherein the distortion model to generate a probability associated with the variation.

32. The apparatus of claim 31, further comprising:
a pseudo corpus that is to store the variation and the associated probability.

33. The apparatus of claim 31, further comprising:
a parameter estimator that is to generate a language model based on the variation and the associated probability.

34. A machine-readable medium having stored thereon a plurality of executable instructions, the plurality of instructions comprising instructions to:
generate a grammars database based on the entries contained in the information database, wherein entries in the grammars database are a compact representation of the entries in the information database;
generate an index database based on the entries contained in the information database;
periodically update the grammars database based on updated entries contained in the information database;
periodically update the index database based on the updated entries contained in the information database;
generate a recognized result of a user's communication based on the updated grammars database;
search the updated index database for a list of matching entries that match the recognized result; and
output the list of matching entries.

35. The machine-readable medium of claim 34 having stored thereon additional executable instructions, the additional instructions comprising instructions to:
generate entries in the grammars database based on the entries in the information database using estimated N-gram statistics.

36. The machine-readable medium of claim 34 having stored thereon additional executable instructions, the additional instructions comprising instructions to:
generate entries in the grammars database based on the entries in the information database using estimated N-gram statistics.

37. The machine-readable medium of claim 34 having stored thereon additional executable instructions, the additional instructions comprising instructions to:
process a plurality of entries of the information database through a distortion model.

38. The machine-readable medium of claim 37 having stored thereon additional executable instructions, the additional instructions comprising instructions to:
generate a transformation rule set for each entry from the plurality of entries; and
transform each entry into a variation of the entry based on the rule set.

39. The machine-readable medium of claim 38 having stored thereon additional executable instructions, the additional instructions comprising instructions to:
generate a probability associated with the variation of the entry.

40. The machine-readable medium of claim 39 having stored thereon additional executable instructions, the additional instructions comprising instructions to:
create a pseudo corpus including the variation and the associated probability.

41. The machine-readable medium of claim 39 having stored thereon additional executable instructions, the additional instructions comprising instructions to:
generate a language model based on the variation and the associated probability using parameter estimation.

42. The machine-readable medium of claim 34 having stored thereon additional executable instructions, the additional instructions comprising instructions to:
search the listing database for the list of matching entries that matched the recognized result based on the updated index database.

43. The machine-readable medium of claim 34 having stored thereon additional executable instructions, the additional instructions comprising instructions to:
process a plurality of entries of the information database through a distortion model.

44. The machine-readable medium of claim 43 having stored thereon additional executable instructions, the additional instructions comprising instructions to:
generate a transformation rule set for each entry from the plurality of entries; and
transform each entry into a variation of the entry based on the rule set.
